(19) United States
(12) Patent Application Publication
(10) Pub. No.: US 2015/0349403 A1
(43) Pub. Date: Dec. 3, 2015

(54) ELECTRONIC DEVICE

(71) Applicant: Kabushiki Kaisha Toshiba, Tokyo (JP)

(72) Inventor: Hideaki Tanaka, Ome Tokyo (JP)

(21) Appl. No.: 14/668,003

(22) Filed: Mar. 25, 2015

(30) Foreign Application Priority Data
May 27, 2014 (JP) 2014-109027

(51) Int. Cl. H01Q 1/24; H01Q 1/27; G04R 20/04; G02F 1/133

(52) U.S. Cl. CPC H01Q 1/241; G02F 1/133; H01Q 1/273; G04R 20/04

(57) ABSTRACT

According to one embodiment, an electronic device according to an embodiment includes a display panel, a transparent glass over an upper surface of the display panel, a chip-type GPS antenna and at least one electronic part coplanar with that of the display panel. A mask is on a surface of the transparent glass, opposite to the GPS antenna and the electronic part, in order to prevent a background reflection of the GPS antenna and the electronic part.

### CROSS-REFERENCE TO RELATED APPLICATIONS

This application is based upon and claims the benefit of priority from Japanese Patent Application No. 2014-109027, filed May 27, 2014, the entire contents of which are incorporated herein by reference.

### FIELD

Embodiments described herein relate generally to a miniature portable electronic device.

### BACKGROUND

Recently, the development of electronic technology has popularized various types of small and light weight electronic devices, typical examples of which are tablet computers, smart phones and personal digital assistants (PDAs).

Even more recently, small electronic devices which can be worn at all times have begun to be developed. An intelligent watch (a smartwatch) can perform various functions including the clock function while being worn on the wrist of a user. It is expected that such a small electronic device will be used for various purposes closely related to the user's everyday life very soon.

An electronic device of this type generally employs a reflective display device (reflective liquid crystal panel), which is thin and does not have a light source, for low power consumption and long-term drive. Such a device is provided with a light-emitting diode (LED) as an external light source for the user to monitor the screen in a dark situation such as at night.

Further, the device generally comprises a Global Positioning System (GPS) module for monitoring the current location or correcting the time.

For an electronic device equipped with a GPS module, it is important to appropriately design where in the device the antenna should be disposed to receive radio signals for the GPS module. In the case where the housing of an electronic device is made of metal, the accuracy of reception of radio signals deteriorates if the antenna is placed inside the housing. To avoid this, it becomes necessary to make an opening for radio signal reception in a part of the housing, for example, and place the antenna underneath the opening. But this step lowers the implementation efficiency.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an appearance of an intelligent watch according to the first embodiment;

FIG. 2 is a view schematically showing an implementation structure of electronic parts in the first embodiment, with a display and a transparent glass being viewed from a side;

FIG. 3 is a view showing the intelligent watch according to the first embodiment, with the transparent glass removed therefrom and the display being viewed from a top;

FIG. 4 is a view showing the intelligent watch according to the first embodiment, with a displayed image on a display being viewed through the transparent glass thereof;

FIG. 5 is a block diagram showing a system configuration of the intelligent watch according to the first embodiment;

FIG. 6 is a view schematically showing an intelligent watch according to the second embodiment, with a display and a transparent glass being viewed from a side;

FIG. 7 is a view showing the intelligent watch according to the second embodiment, with the transparent glass removed therefrom and the display being viewed from a top;

FIG. 8 is a view schematically showing an intelligent watch according to the third embodiment, with a display and a transparent glass being viewed from a side;

FIG. 9 is a view showing the intelligent watch according to the third embodiment, with the transparent glass removed therefrom and the display being viewed from a top; and

FIG. 10 is a perspective view showing an appearance of an intelligent watch according to the fourth embodiment.

### DETAILED DESCRIPTION

Various embodiments will be described hereinafter with reference to the accompanying drawings.

In general, according to one embodiment, an electronic device according to an aspect of the embodiments includes a display panel, a transparent glass over an upper surface of the display panel, a chip-type GPS antenna and at least one electronic part coplanar with that of the display panel. A mask is on a surface of the transparent glass, opposite to the GPS antenna and the electronic part, in order to prevent a background reflection of the GPS antenna and the electronic part.

Embodiments will now be described with reference to drawings.

### First Embodiment

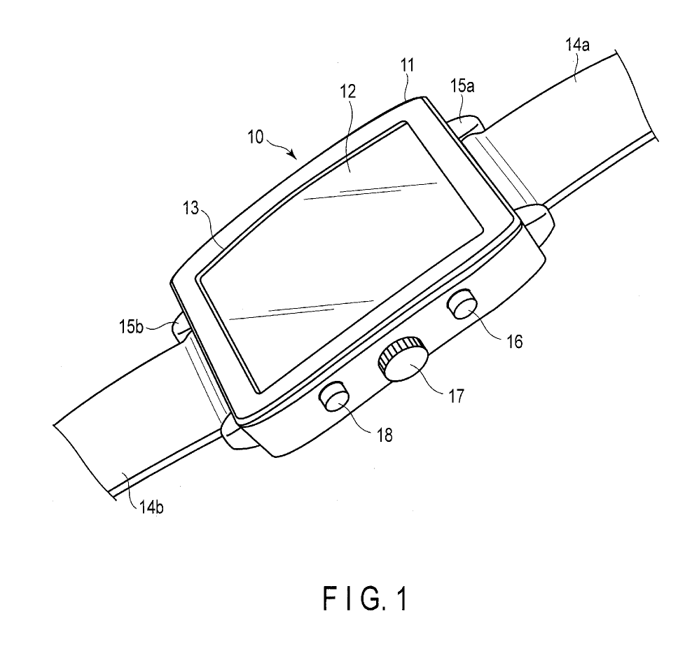

FIG. 1 is a perspective view showing an appearance of an electronic device according to the first embodiment. In this embodiment, the electronic device is a mobile electronic device comprising a display. The following descriptions will be made based on an assumption that the electronic device is embodied as an intelligent watch (smartwatch) capable of executing various functions including that of a wristwatch.

An intelligent watch 10 is a miniature computing device which can be driven by a battery. FIG. 1 shows an example of the intelligent watch 10, which comprises a rectangular display.

The intelligent watch 10 comprises a metal-made housing 11 which constitutes a main body of the watch. The housing 11 accommodates various electronic parts therein. A rectangular opening is made in a part of an upper surface of the housing 11, and a rectangular display 12 is incorporated in the opening. The display 12 is a reflection liquid crystal panel, which displays images by reflection of external light. On a screen of the display 12, a transparent glass 13 which has a rectangular shape larger than that of the display 12 is provided. The transparent glass 13 is used as a cover which covers the screen of the display 12.

Bands 14a and 14b are attached to sides of the housing 11 in order to allow the intelligent watch 10 to be worn on the wrist of a user. An end of band 14a is attached to one end of the housing 11 by an attachment part 15a, whereas an end of band 14b is attached to the other end of the housing 11 by an attachment part 15b.

One side surface of the housing 11 comprises some operation buttons. This example shows a case where three operation buttons 16, 17 and 18 are provided on a right-side surface of the housing 11. These operation buttons 16, 17 and 18 are used to switch display images and the like. The operation button 17 may be an equivalent to a watch crown.

Next, the implementation structure of the electronic parts used in the intelligent watch 10 will now be described.

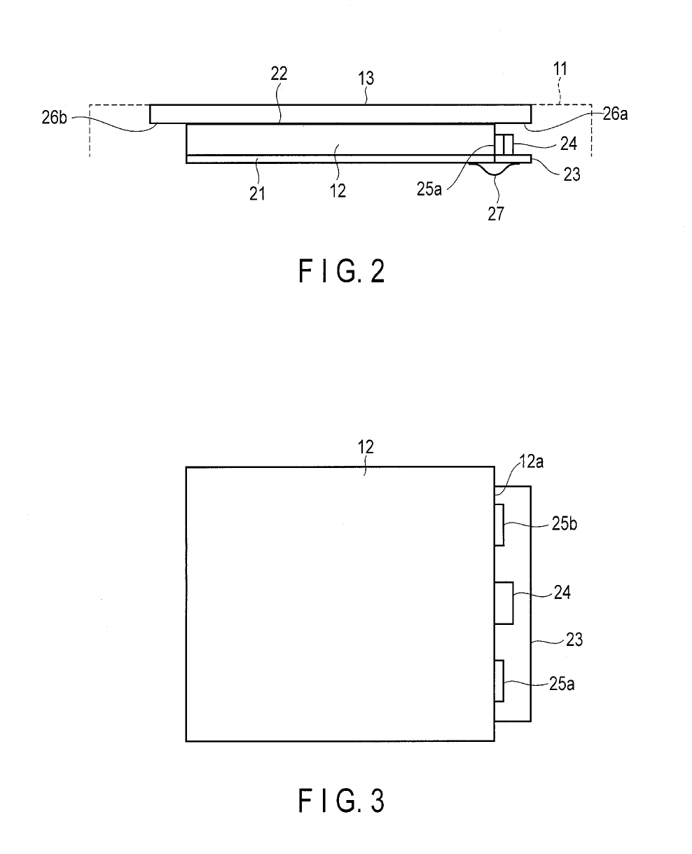

FIGS. 2 and 3 each are a view schematically showing an implementation structure of electronic parts in the first embodiment. FIG. 2 shows a state in which the display 12 and the transparent glass 13 of the intelligent watch 10 are viewed from the side. FIG. 3 shows a state in which the display 12 is viewed from the top while the transparent glass is removed from the intelligent watch 10.

The display 12 is implemented on a main substrate 21 provided in the housing 11. The transparent glass 13 is provided via an adhesive 22 on an upper surface of the main substrate 21. The transparent glass 13 has a size larger than that of the display 12. The display 12 is a reflection liquid crystal panel and a display screen thereof comprises touch sensors thereon though they are not shown in the figure.

On a rear surface of the main substrate 21, various electronic parts are implemented including a CPU, a memory and the like, which are not shown. A sub-substrate 23, separately from the main substrate 21, is provided in the housing 11. The sub-substrate 23 is located on an outer side to an end portion 12a of the screen of the display 12. The sub-substrate 23 is electrically connected to the main substrate 21 via a flexible cable 27. On the sub-substrate 23, a chip-type GPS antenna 24 and a plurality (two in this example) of light-emitting diodes (LEDs) 25a and 25b are implemented.

The GPS antenna 24 is a chip-type antenna to receive GPS radio signals. The GPS antenna 24 may be constituted by a single chip including a radio signal receiver (not shown). LEDs 25a and 25b are light-emitting elements and are used as external light sources to light the screen of the display 12. The GPS antenna 24 and LEDs 25a and 25b are implemented in such an arrangement that they are placed alongside each other on the same plane as that of the display 12 underneath the transparent glass 13.

As shown in FIG. 3, the display 12 comprises a rectangular display screen. The GPS antenna 24 and LEDs 25a and 25b on the sub-substrate 23 are arranged alongside each other on an outer side of one end 12a of the display screen. Of these, the GPS antenna 24 is located near a center of the end 12a of the screen. LEDs 25a and 25b are located respectively near both sides of the end 12a of the screen.

Note that this example describes a case where two LEDs, namely, LEDs 25a and 25b, are provided, but the number of LEDs is not particularly limited. As an external light source for the display 12, it suffices if at least one LED is provided.

On a surface of the transparent glass 13, opposite to the GPS antenna 24 and LEDs 25a and 25b, a mask 26a is formed by printing or deposition in the form of a black band having a predetermined width.

In the example shown in FIG. 2, mask 26a is provided on one end side of the rear surface of the rectangular transparent glass 13. Mask 26a is provided in order to prevent a background reflection of the GPS antenna 24 and the LEDs 25a and 25b underneath the transparent glass 13. Mask 26a has a light blocking property and serves to prevent the transmission of light of LEDs 25a and 25b.

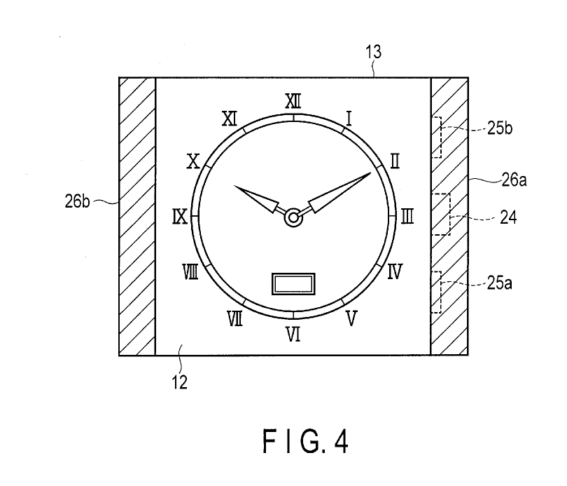

Note that if mask 26a is provided on the surface of the transparent glass 13, it may be easily peeled off as the user unintentionally touches it. To avoid this, it is preferable that mask 26a be provided on the rear surface of the transparent glass 13. Further, the user views the images on the display 12 through the transparent glass 13 and therefore it is preferable in term of appearance that a mask 26b similar to mask 26a be provided on the other end side of the rear surface of the transparent glass 13 (FIG. 4).

FIG. 4 is a diagram showing an image on the display 12 of the intelligent watch 10 as viewed through the transparent glass 13. This example shows a dial plate of a watch being displayed on the display 12.

Masks 26a and 26b in the form of black bands are shown in both sides (right and left sides in this example) of the screen of the display 12. Masks 26a and 26b are provided on the transparent glass 13. With this structure, if the image on the display 12 is switched, the masks 26a and 26b are always situated on both sides of the screen of the display 12 to hide the GPS antenna 24 and LEDs 25a and 25b from the eyes of the user.

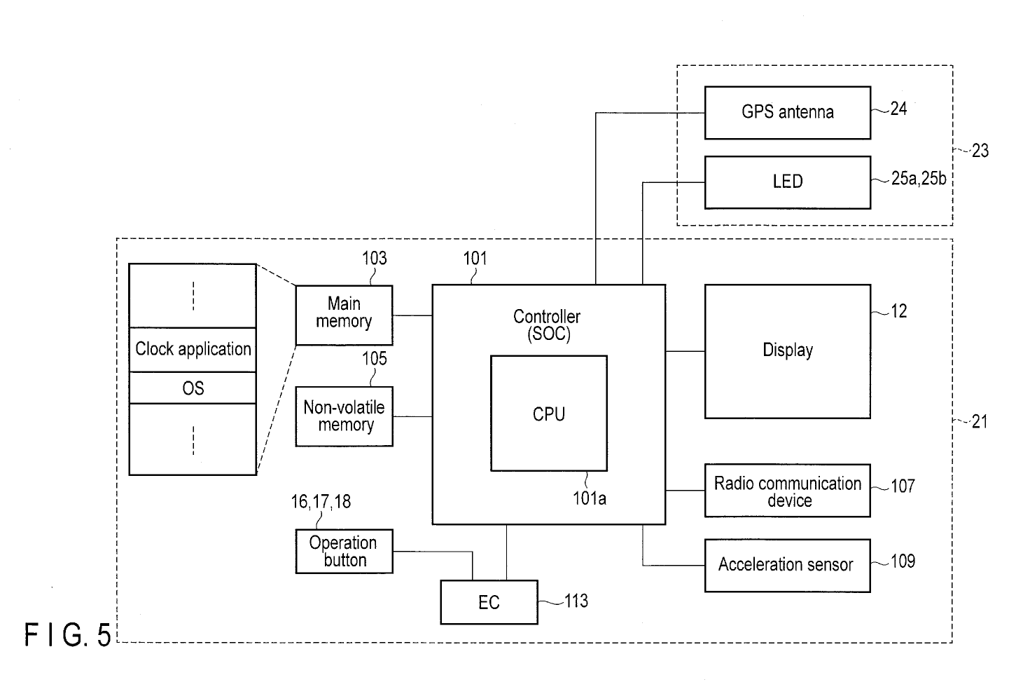

FIG. 5 is a block diagram showing a system configuration of the intelligent watch 10.

The intelligent watch 10 comprises, in addition to the GPS antenna 24 and LEDs 25a and 25b, a controller 10, a main memory 103, a nonvolatile memory 105, a radio communication device 107, an acceleration sensor 109, an embedded controller (EC) 113 and the like.

The controller 101 is configured to execute various functions including that of a wristwatch. The controller 101 controls various components of the intelligent watch 10. The controller 101 may be realized by a system-on-a-chip (SOC) comprising various functional modules including a CPU 101a. The CPU 101a functions as a processor (one or more cores) configured to execute various programs loaded into the main memory 103 from the nonvolatile memory 105.

These programs include an operation system and various types of application/utility programs. The application/utility programs include a clock application program. The clock application is a program to execute the wristwatch functions. Further, the application/utility programs may include application programs cooperative with other electronic devices (including smartphones). This application program is configured to display various information items on the display 12, such as notification of reception of incoming mail, contents of incoming mail, etc.

The radio communication device 107 is a communication interface used for radio communication with another electronic device (such as a smartphone). The radio communication device 107 may be, for example, a Bluetooth (registered trademark) device. The controller 101 is capable of cooperating with another electronic device by utilizing the radio communication device 107 and thereby displaying various information items on the display 12.

The acceleration sensor 109 is used to detect the movement of the user who is wearing the intelligent watch 10.

The embedded controller (EC) 113 is configured to execute a power management function of turning on or off the intelligent watch 10 in reply to an operation by the user.

Of these electronic parts, at least the GPS antenna 24 and LEDs 25a and 25b are implemented on the sub-substrate 23, and are arranged alongside the display 12 underneath the transparent glass 13.

With this structure, various functions of the intelligent watch 10 can be utilized while being worn on the wrist of a user. For example, when the wristwatch function is initiated, such a dial plate of a watch such as shown in FIG. 14 is displayed on the display 12. Thus, the current time can be confirmed while the user is wearing the intelligent watch 10 on the wrist.

The display 12 is a reflection liquid crystal panel, which utilizes external light for display. Consequently, in a dark place or at night, for example, it is difficult to confirm images on the display 12. Here, LEDs 25a and 25b can be lit by operating one of the operation buttons 16, 17 and 18. When LEDs 25a and 25b are lit, they irradiate light from one end side of the display 12, and the light diffuses over the entire screen via the transparent glass 13.

Masks 26a and 26b which have a light-blocking property are provided respectively on both sides of the transparent glass 13. With this structure, light does not leak from both sides of the transparent glass 13, and thus only the screen of the display 12 is brightly lit. In this case, as shown in FIG. 3, LEDs 25a and 25b are provided respectively on both sides of the screen of the display 12, one on each side. Thus, the entire screen can be brightly lit without unevenness.

Note that a light-diffusing material may be applied on the screen of the display 12 in order to further suppress unevenness of lighting, thereby making it possible to light the entire display screen further evenly and brightly.

The GPS antenna 24 is used to display the current location and to correct the time of the clock. The GPS antenna 24 is placed along with LEDs 25a and 25b underneath the transparent glass 13. With this structure, the GPS radio signals can be received through the transparent glass 13. The GPS antenna 24, together with LEDs 25a and 25b, is masked by mask 26a, and thus the appearance as a watch is not spoiled. Thus, with such a structure that the GPS antenna 24 is implemented underneath the transparent glass 13, it is possible to receive radio signals without requiring a step of making an opening for receiving radio signals in the housing 11. Accordingly, it is possible to display the current location and to correct the time of the clock.

Here, when the GPS antenna 24 and LEDs 25a and 25b are arranged alongside on an outer side of the one end 12a of the screen of the display 12, the GPS antenna 24 and LEDs 25a and 25b can be masked altogether. Further, with the above-described structure, the GPS antenna 24 and LEDs 25a and 25b are accommodated in a thickness direction of the display 12, thereby making it possible to thin the housing 11.

Note that in the first embodiment described above, the main substrate 21 and the sub-substrate 23 are provided separately, but they may be integrated as one unit.

### Second Embodiment

Next, the second embodiment will now be described.

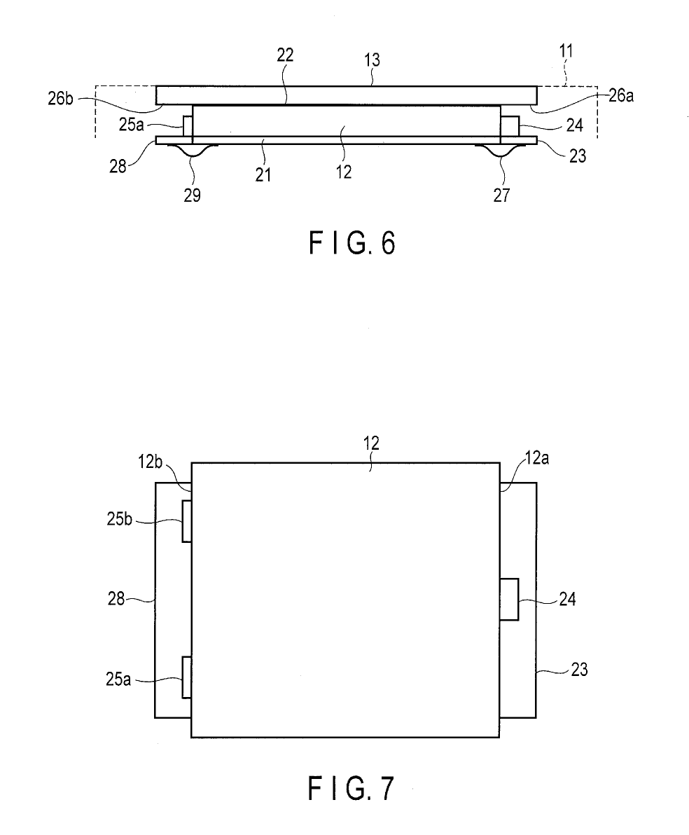

FIGS. 6 and 7 schematically show an implementation structure of electronic parts in the second embodiment. FIG. 6 illustrates a display 12 and a transparent glass 13 of an intelligent watch 10 as viewed from the side. FIG. 7 illustrates the display 12 as viewed from the top while the transparent glass 13 being removed from the intelligent watch 10.

In the first embodiment described above, the GPS antenna 24 and LEDs 25a and 25b are arranged alongside each other on an outer side of one end 12a of the screen of the display 12. By contrast, according to the second embodiment, a GPS antenna 24 is disposed on an outer side of one end 12a of the screen of the display 12, whereas LEDs 25a and 25b are arranged on an outer side of the other end 12b of the display 12.

The GPS antenna 24 is implemented on a sub-substrate 23 but underneath the transparent glass 13. LEDs 25a and 25b are implemented on another sub-substrate 28 separated from the sub-substrate 28 but underneath the transparent glass 13. The sub-substrate 28 is disposed on an outer side of one end 12b of the display 12 and is electrically connected to the main substrate 21 via a flexible cable 29.

As shown in FIG. 7, the display 12 comprises a rectangular display screen. The GPS antenna 24 on the sub-substrate 23 is located near a center of the end 12a of the screen is disposed on an outer side of one end 12a of the display screen. LEDs 25a and 25b on the sub-substrate 23 are located respectively near both sides of the other end 12b of the screen.

Note that this example describes a case where two LEDs, namely, LEDs 25a and 25b, are provided, but the number of LEDs is not particularly limited. As an external light source for the display 12, it suffices if at least one LED is provided.

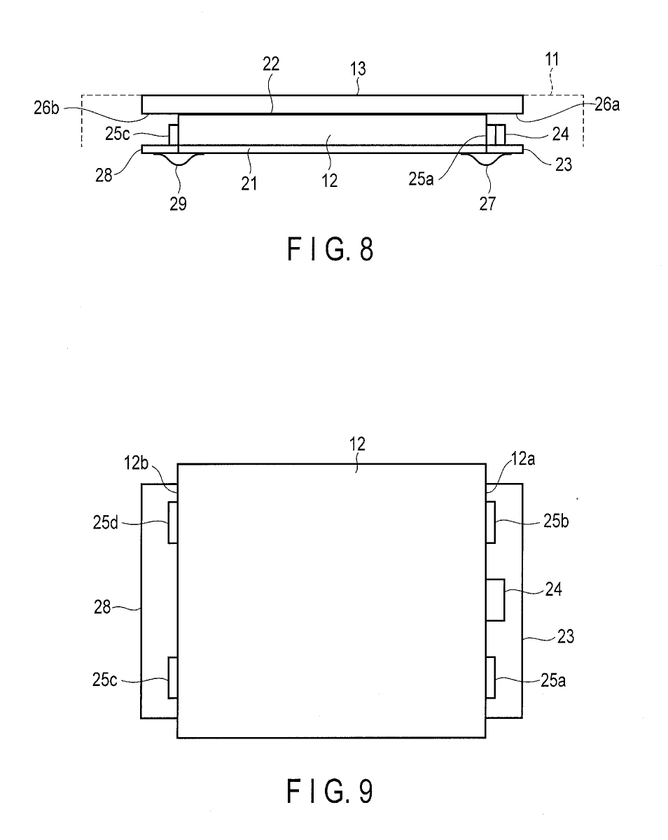

On surfaces of the transparent glass 13, opposite to the GPS antenna 24 and LEDs 25a and 25b, masks 26a and 26b are formed respectively by printing or deposition each in the form of a black band having a predetermined width. In the example shown in FIG. 8, mask 26a is provided on one end side of the rear surface of the rectangular transparent glass 13, and mask 26b is provided on the other end side. Mask 26a is provided in order to prevent a background reflection of the GPS antenna 24 and LEDs 25a and 25b underneath the one end side of the transparent glass 13. Mask 26b is provided in order to prevent a background reflection of LEDs 25c and 25d underneath the other end side of the transparent glass 13.

As described above, even in the case where LEDs 25a and 25b are arranged on the other end side of the display 12, LEDs 25a and 25b are arranged alongside each other together with the GPS antenna 24 on a plane as that of the display 12. With this structure, LEDs 25a and 25b are accommodated in a thickness direction of the display 12, thereby making it possible to thin the housing 11.

### Third Embodiment

Next, the third embodiment will now be described.

FIGS. 8 and 9 schematically show an implementation structure of electronic parts in the third embodiment. FIG. 8 illustrates a display 12 and a transparent glass 13 of an intelligent watch 10 as viewed from the side. FIG. 9 illustrates the display 12 as viewed from the top while the transparent glass 13 being removed from the intelligent watch 10.

In the third embodiment, four of LEDs 25a, 25b, 25c and 25d are used. Of these, LEDs 25a and 25b are implemented together with a GPS antenna 24 on a sub-substrate 23 but underneath the transparent glass 13. LEDs 25c and 25d are implemented on another sub-substrate 28 separated from the sub-substrate 23 but underneath the transparent glass 13. The sub-substrate 28 is disposed on an outer side of the other end 12b of the display 12 and is electrically connected to the main substrate 21 via a flexible cable 29.

As shown in FIG. 9, the display 12 comprises a rectangular display screen. The GPS antenna 24 and LEDs 25a and 25b on the sub-substrate 23 are arranged in line on an outer side of one end 12a of the screen. Of these, the GPS antenna 24 is located near a center of the end 12a of the screen. LEDs 25a and 25b are located respectively near both sides of the other end 12b of the screen. LEDs 25c and 25d on the sub-substrate 28 are located respectively near both sides of the other end 12b of the screen.

On surfaces of the transparent glass 13, opposite to the GPS antenna 24, LEDs 25a and 25b, and to LEDs 25c and 25d, masks 26a and 26b are formed respectively by printing or deposition each in the form of a black band having a predetermined width.

In the example shown in FIG. 8, mask 26a is provided on one end side of the rear surface of the rectangular transparent glass 13, and mask 26b is provided on the other end side. Mask 26a is provided so as to prevent a background reflection of the GPS antenna 24, LEDs 25a and 25b underneath the one end side of the transparent glass 13. Mask 26b is provided in order as to prevent a background reflection of LEDs 25c and 25d underneath the other end side of the transparent glass 13.

As described above, even in the case where LEDs 25c and 25d are added, LEDs 25c and 25d are arranged alongside each other together with the GPS antenna 24 on a plane as that of the display 12. With this structure, LEDs 25c and 25d are accommodated in a thickness direction of the display 12, thereby making it possible to thin the housing 11.

### Fourth Embodiment

Next, the fourth embodiment will now be described.

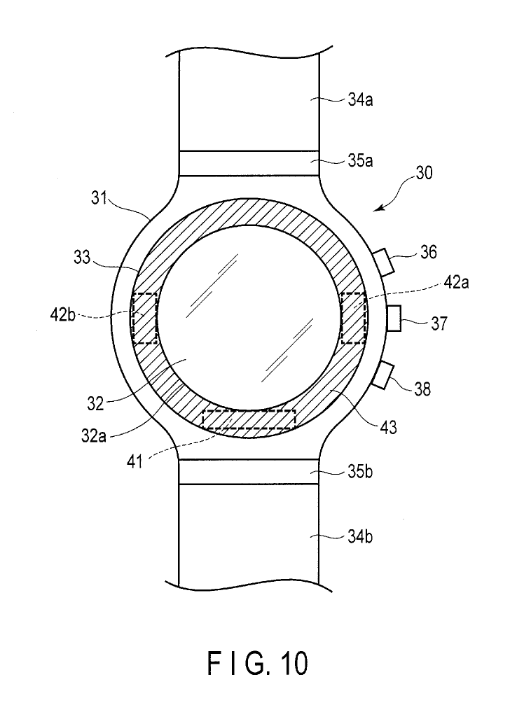

FIG. 10 is a perspective view showing an appearance of an electronic device according to the fourth embodiment. FIG. 10 illustrates an example of an intelligent watch 30 comprising a circular display.

The intelligent watch 30 comprises a metal-made housing 31 which constitutes a main body of the watch. The housing 31 accommodates various electronic parts therein. A circular opening is made in a part of an upper surface of the housing 31, and a display 32 comprising a circular display screen is incorporated in the opening. The display 32 is a reflection liquid crystal panel, which displays images by reflection of external light. On a screen of the display 32, a transparent glass 33 which has a circular shape larger than that of the display 32 is provided. The transparent glass 33 is used as a cover which covers the screen of the display 32.

Bands 34a and 34b are attached to respective sides of the housing 31 in order to allow the intelligent watch 30 to be worn on the wrist of a user. An end of band 34a is attached to one end of the housing 31 by an attachment part 35a, whereas an end of band 34b is attached to the other end of the housing 31 by an attachment part 35b.

One side surface of the housing 11 comprises some operation buttons. This example shows a case where three operation buttons 36, 37 and 38 are provided on a right-side surface of the housing 31. These operation buttons 36, 37 and 38 are used to switch display images and the like. The operation button 37 may be an equivalent to a watch crown.

In this example, a GPS antenna 41 and LEDs 42a and 42b are located underneath the transparent glass 33. In this arrangement, the GPS antenna 41 and LEDs 42a and 42b are implemented alongside each other at any positions on an outer side of a circumferential portion 32a of the display 32 in a plane same as that of the display 32.

On surfaces of the transparent glass 33, opposite to the GPS antenna 41 and LEDs 42a and 42b, a mask 43 is formed respectively by printing or deposition each in the form of a black band having a predetermined width. In the example shown in FIG. 10, the mask 43 is provided on the circumferential side of the rear surface of the circular transparent glass 33. The mask 43 is provided in order to prevent a background reflection of the GPS antenna 41 and LEDs 42a and 42b underneath the transparent glass 13. The mask 43 has a light blocking property and prevents the transmission of light of LEDs 42a and 42b.

As described above, with such a structure that the GPS antenna 41 is implemented underneath the transparent glass 33 in the circular intelligent watch 30, it is possible to receive radio signals without requiring a step of making an opening for receiving radio signals in the housing 31. Accordingly, it is possible to display the current location and to correct the time of the clock.

Here, with the structure that the GPS antenna 41 and LEDs 42a and 42b are arranged alongside on an outer side of the circumferential portion 32a of the display 32, the GPS antenna 41 and LEDs 42a and 42b can be masked altogether. Further, with the above-described structure, the GPS antenna 41 and LEDs 42a and 42b are accommodated in a thickness direction of the display 32, thereby making it possible to thin the housing 31.

Note that the shape of the intelligent watch is not limited to being circular, but various shapes may be similarly applicable including triangular, rhomboid, etc. In other words, with the structure that a GPS antenna and LEDs are implemented in a plane the same as that of a display underneath a glass member which covers the screen of the display, it is possible to realize an electronic device capable of receiving radio signals without requiring a step of processing its housing, and also to reduce the thickness of the housing.

Further, the electronic parts implemented along with the GPS antenna are not limited to LEDs, but they may include an acceleration sensor.

According to the embodiments described above, it is possible to provide a thin electronic device with efficient implementation of various electronic parts including a GPS antenna therewithin, without requiring a step of processing its housing.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a display panel;
a transparent glass over an upper surface of the display panel;
a chip-type GPS antenna and at least one electronic part coplanar with that of the display panel; and
a mask on a surface of the transparent glass, opposite to the GPS antenna and the electronic part, the mask preventing a background reflection of the GPS antenna and the electronic part.

2. The electronic device of claim 1, wherein
the display panel comprises a rectangular screen,
the GPS antenna and the at least one electronic part are on an outer side of an end of the rectangular screen.

3. The electronic device of claim 1, wherein
the display panel comprises a rectangular screen,
the GPS antenna is on an outer side of an end of the rectangular screen, and
the at least one electronic part is on an outer side of another end of the rectangular screen.

4. The electronic device of claim 1, wherein
the display panel comprises a circular screen, and
the GPS antenna and the at least one electronic part are on an outer side of a circumference of the circular screen.

5. The electronic device of claim 1, wherein
the display panel is a reflection liquid crystal display panel.

6. The electronic device of claim 5, wherein
the at least one electronic part is a light-emitting device to light the reflection liquid crystal display panel.
